(19) United States
(12) Patent Application Publication
(10) Pub. No.: US 2023/0077797 A1
(43) Pub. Date: Mar. 16, 2023

(54) WIRELESS POWER TRANSMISSION

(71) Applicant: Hewlett-Packard Development Company, L.P., Spring, TX (US)

(72) Inventors: Chien-Pai Lai, Taipei City (TW); Chih-Hung Chien, Taipei City (TW); Chung-Chun Chen, Taipei City (TW); Xinchang Chen, Taipei City (TW)

(21) Appl. No.: 17/471,800

(22) Filed: Sep. 10, 2021

(51) Int. Cl. H02J 50/23; H02J 7/35; H01Q 21/06; H02J 50/00; H02J 7/00

(52) U.S. Cl. CPC H02J 50/23; H01Q 21/065; H02J 7/35; H02J 7/0047; H02J 50/005; H02J 2207/40

(57) ABSTRACT

In some examples, the disclosure describes an electronic device with a display member, a base member rotatably coupled to the display member, the base member including an input component, a photovoltaic component coupled to an exterior surface of the display member to generate an amount of solar power, and an array of millimeter wave (mmWave) antennas to wirelessly transmit the amount of solar power to an external device.

### BACKGROUND

Some electronic devices such as mobile phones, headphones, tablets, styluses, and/or laptops, etc. utilize batteries to provide power to the electronic device. Some batteries are rechargeable. For instance, some electronic devices rely on a wired connection to a power source to provide power to and thereby recharge a battery in the electronic devices.

### BRIEF DESCRIPTION OF THE DRAWINGS

FIG. 1A illustrates a diagram of an example of an electronic device including a photovoltaic component and an array of millimeter wave (mmWave) antennas suitable with wireless power transmission.

FIG. 1B illustrates a diagram of another example of an electronic device including a photovoltaic component and an array of mmWave antennas suitable with wireless power transmission.

FIG. 2 illustrates a view of an example of an electronic device including a photovoltaic component and an array of mmWave antennas suitable with wireless power transmission.

FIG. 3 illustrates a view of another example of an electronic device including a photovoltaic component and an array of mmWave antennas suitable with wireless power transmission.

FIG. 4 illustrates a diagram of an example of a power management controller suitable with wireless power transmission.

FIG. 5 illustrates an example of a flow diagram of a flow for providing wireless power transmission.

### DETAILED DESCRIPTION

Various electronic devices include a rechargeable battery. A wired connection (e.g., a cable) permits wired charging of the rechargeable battery. A wireless charging device permits wireless charging of the rechargeable battery. As used herein, a wireless charging device refers to an electronic device that is capable of wirelessly recharging a rechargeable battery. Wirelessly charging (i.e., wireless charging, wirelessly charged), as used herein, refers to recharging a battery in the absence of a wired connection between the electronic device and a source of power external to the electronic device. For example, an electronic device is positioned on and/or near a wireless charging mat to wirelessly charge a rechargeable battery of the electronic device. However, such approaches rely on the electronic device being in a particular orientation (e.g., on a surface of the wireless charging mat) to recharge the rechargeable battery, and therefore do not charge electronic devices in other orientations (e.g., adjacent to the wireless charging mat). Moreover, such approaches inherently add an additional physical device (the wireless charging mat) to a user environment which detracts from a user experience. Additionally, such approaches, due to an absence of sustainable (e.g., solar) power source, may not be able to sustainably deliver power.

Accordingly, the disclosure is directed to millimeter wave (mmWave) solar power transmission. As detailed herein, wireless power transmission sustainably provisions solar power to electronic devices (e.g., laptop, all-in-one (AIO) computing device, etc.), an external device (e.g., mouse, stylus, etc.), or a combination thereof. For example, an electronic device with a photovoltaic component (e.g., a solar panel) captures an amount of solar power and an array of mmWave antennas wirelessly transmits the amount of solar power to an external device such as an external device that is adjacent to (but is not in contact with) the electronic device.

Notably, in some instances, an electronic device includes a photovoltaic component that is spaced a distance away from and/or located on a different surface than an array of mmWave antenna (e.g., an array of mmWave transmission antennas). For instance, an AIO computer includes a photovoltaic panel located on “top” surface of the AIO computer and an mmWave transmission antenna located on the “bottom” surface of the AIO computer. Such an orientation readily permits generation of solar power and also readily permits power transmission (e.g., by minimizing a transmission distance) between the array of mmWave antennas and an external device receiving the transmitted power. Moreover, employing the mmWave radio frequencies efficiently transmits power (e.g., due to an efficient conversion between visual light and the mmWave frequency) as opposed to other approaches such as those that employ alternate wireless transmission frequencies/mechanisms (e.g., near-field communication (NFC)). Further, in some instances the electronic device is powered entirely by sustainable solar power and thus is free of a power-supply (without a power supply) and related circuitry.

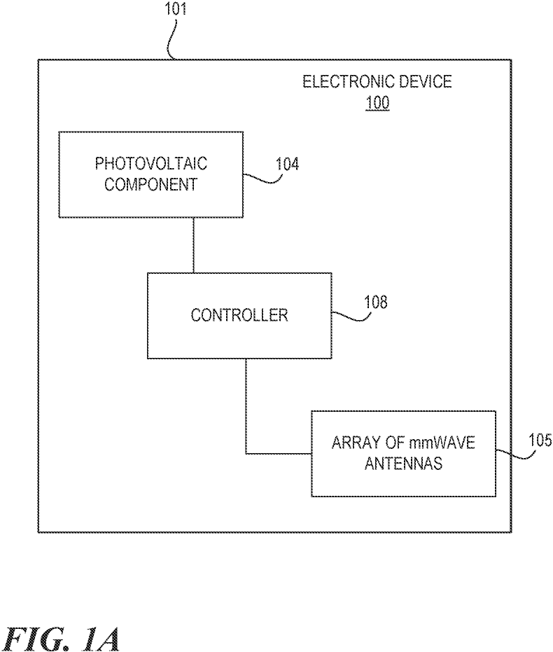

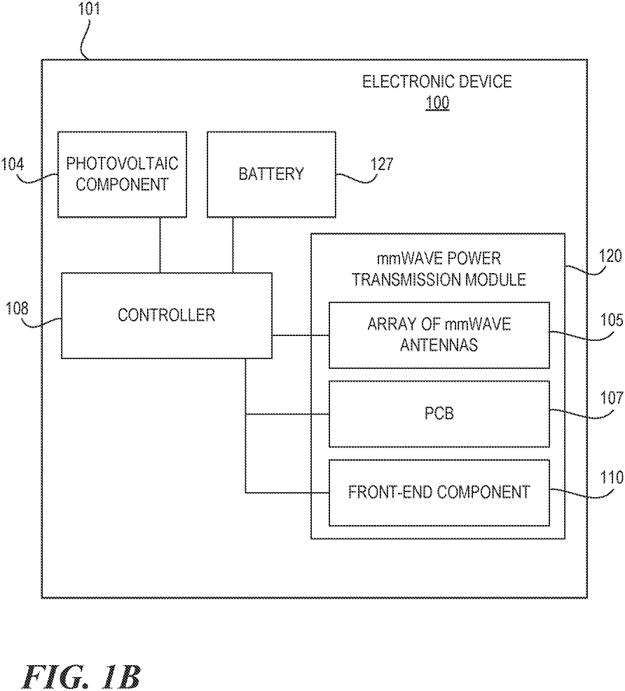

FIG. 1A illustrates a diagram of an example of an electronic device 100 including a photovoltaic component 104 and an array of mmWave antennas 105 suitable with wireless power transmission. FIG. 1B illustrates a diagram of another example of an electronic device 100 including a photovoltaic component 104 and an array of mmWave antennas 105 suitable with wireless power transmission.

Examples of the electronic device 100 include a mobile phone, a tablet, a laptop computer, a display member, an all-in-one (AIO) computer, a desktop computer, or combinations thereof. As used herein, an AIO computer refers to a computer which integrates the internal components into the same case as a display member and offers the touch input functionality of the tablet devices while also providing the processing power and viewing area of desktop computing systems.

A housing 101 forms an exterior surface of the electronic device 100. Examples of suitable housing 101 materials include fabric, metal, wood, plastic, or combinations thereof, among other suitable materials.

The electronic device 100 includes a photovoltaic component 104. The photovoltaic component 104 refers to a device that absorbs energy from the sun or other light source to generate solar electricity (i.e., solar power). In some instances, the photovoltaic component 104 is a solar panel. The solar panel harnesses solar energy via a photovoltaic panel that converts incident sunlight into an electrical current using the photovoltaic effect. In some instances, photovoltaic component 104 is a solar panel that includes a plurality of interconnected photovoltaic panels each having a plurality of structural and electrical units referred to as photovoltaic modules.

Each photovoltaic module includes a plurality of photovoltaic cells (e.g., solar cells) that converts sunlight directly into a usable form of energy (e.g., electricity). In some instances, the solar panel includes a rigid structure or flexible structure with photovoltaic cells comprised wafers of light absorbing materials (e.g., a wafer photovoltaic panel). For instance, the photovoltaic cells include a wafer including materials (e.g., layers) such as a superstrate material (e.g., glass), an antireflective material, a front contact material, a photovoltaic material, a back contact material, and/or a metal backing material. Example photovoltaic materials include crystalline silicon, monocrystalline silicon, polycrystalline silicon, amorphous silicon, cadmium telluride, copper indium selenide, and/or various other materials and/or combinations thereof capable of converting sunlight into a usable form of energy (e.g., solar power). The photovoltaic component 104 is sized and/or shaped to be coupled to an exterior surface of the housing 101 of the electronic device 100, as detailed herein.

Examples of suitable types of mmWave antennas include printed antennas, patch antennas, dipole antennas, monopole antennas, Yagi-uda antennas, and/or slot antennas. For instance, employing a printed antenna array provides mmWave transmission capabilities, and yet has a physical footprint that unlike other types of mmWave antennas (e.g., mmWave horn/reflector antennas) is suitable for use with electronic device such as the electronic device 100. The mmWave antenna array includes a plurality of individual mmWave antennas. A total number of the individual mmWave antennas in the array is in a range from 3 to 256 individual mmWave antennas. The array of mmWave antennas 105 is located within or partially within the housing 101. In some instances, the array of mmWave antennas 105 is located in the electronic device 100 such that the array of mmWave antennas 105 is not visible from a vantage of a user of the electronic device 100. In some instances, the array of mmWave antennas 105 is included in a mmWave power transmission module (e.g., mmWave power transmission module 120 as illustrated in FIG. 1B), as detailed herein.

The mmWave power transmission module 120 includes a printed circuit board (PCB) 107, a mmWave front end component 110 coupled to the PCB 107, and the array of mmWave antennas 105 that are coupled to the PCB 107. The mmWave front end component 110 includes various circuitry for converting, amplifying, modifying a frequency of, and/or otherwise altering aspects of the amount of solar energy generated by the photovoltaic component 104 to permit the amount of solar energy to be transmitted by the array of mmWave antennas 105. The array of mmWave antennas 105 is coupled to a first side of the PCB 107, a second side of the PCB 107 that is opposite of the second side, or a combination thereof. In this way, the array of mmWave antennas 105 is arranged dependent on a given application to directionally transmit the amount of solar power via various polarization and/or beam-forming techniques. For instance, the array of mmWave antennas 105 is included on both the first side and the second side of the PCB 107 to increase potential angles at which the mmWave antennas 105 directionally transmits the amount of solar power generated by the photovoltaic component 104, as compared to other approaches that employ antennas on an individual surface of a component.

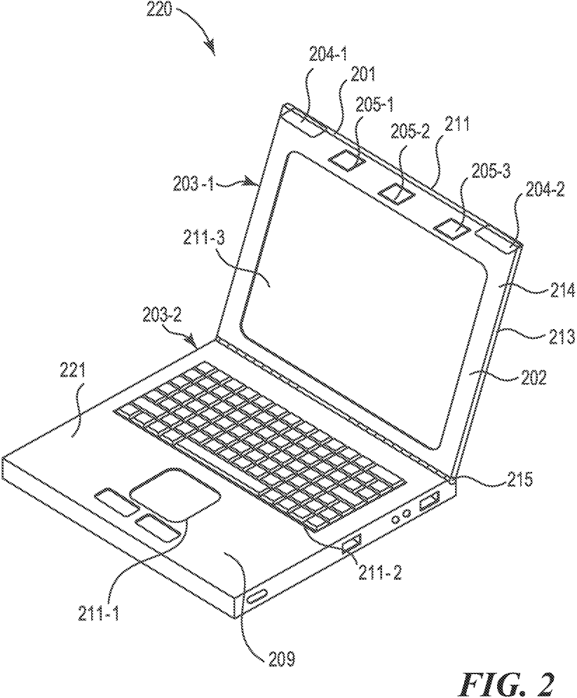

The device includes a rechargeable battery 127. The rechargeable battery 127 is located inside the housing 101. The battery, in some instances, is located adjacent to a top surface (e.g., top surface 211 as illustrated in FIG. 2), a front surface (e.g., front surface 214 as illustrated in FIG. 2), among other possible locations. The rechargeable battery 127 is located adjacent to a same or different surface as the photovoltaic component 104. Similarly, the rechargeable battery 127 is located adjacent to a same or different surface as the array of mmWave antennas 105. In various instances, the rechargeable battery 127 is located inside the housing 101 near the same surface (e.g., a top surface) as the photovoltaic component 104. In various instances, the rechargeable battery 127 is located inside the housing 101 near a different surface (e.g., the top surface) than a surface (e.g., a bottom surface) that is near the array of mmWave antennas 105. As used herein, a surface that is “near” a component (e.g., the photovoltaic component 104 and/or the array of mmWave antennas 105) refers to a surface or combination of surfaces that are most proximate to a location of the component.

FIG. 2 illustrates a view of an example of an electronic device 220 including a photovoltaic component (e.g., a solar panel) such as a first photovoltaic component 204-1, a second photovoltaic component 204-2, etc. and an array of mmWave antennas such as a first mmWave antenna 205-1, a second mmWave antenna 205-2, a third mmWave antenna 205-3, etc.

As illustrated in FIG. 2, the electronic device 220 includes a housing 201 with a bezel 202. The housing 201 forms an exterior surface of the electronic device 100. For instance, the housing 201 forms a display member 203-1 and a base member 203-2, as illustrated in FIG. 2. The display member 203-1 is rotatably coupled to the base member 203-2 to permit the display member 203-1 to rotate relative to the base member 203-2 between various positions. For instance, the electronic device 200, as illustrated in FIG. 2, is in a first position (with the photovoltaic component 204 and the array of mmWave antennas 205 exposed) in which the electronic device 200 is open and permits use of the input component (e.g., use of the first input component 211-1). However, other positions are possible.

The bezel 202 refers to a component that surrounds an electronic display panel such as a touchscreen of an electronic device. The bezel 202 surrounds a periphery of an electronic display panel such as a graphical user interface included in an electronic device such as those described herein. The bezel 202 is formed of a same or different material than a material forming other portions of the housing 201.

The first input component 211-1, the second input component 211-2, and the third input component 211-3 are a trackpad, a key array, and a touch screen, respectively, as illustrated in FIG. 2. However, a type, a quantity, and/or a location of the input component is variable.

The photovoltaic component (e.g., the first photovoltaic component 204-1) is separate from the array of mmWave antennas (e.g., the first mmWave antenna 205-1). Such separation avoids/mitigates any physical/electromagnetic interference between different components and reduces a transmission distance between the array of mmWave antennas and an external device. As used herein, being “separate” refers to being physically distinct and disposed at a different physical location. For instance, as illustrated in FIG. 2, the photovoltaic component (e.g., the first photovoltaic component 204-1) are disposed at a location other than locations of from the array of mmWave antennas (e.g., a location of the first mmWave antenna 205-1).

The electronic device 200 includes a palm rest area 209. As used herein, a palm rest area refers to an area of a housing 201 of the electronic device 200 that the user is to contact (e.g., contact with their palms) when using the electronic device 200. For instance, as illustrated in FIG. 2, the palm rest area 209 is located in the base member 203-2 such that a user is to contact the palm rest area 209 when interacting with an input component.

While illustrated as being visible for descriptive purposes, the array of mmWave antenna such as the first mmWave antenna 205-1, a second mmWave antenna 205-2, and a third mmWave antenna 205-3 are located inside of the housing 201. In some instances, the array of mmWave antenna 205 is located inside of the display member 203-1, the base member 203-2, or a combination thereof. For instance, as illustrated in FIG. 2, each antenna of the array of mmWave antennas 205 is located in the display member 203-1. Having each antenna of the array of mmWave antenna be located in the display member 203-1, particularly near or at a top surface 211 of the display member 203-1 as illustrated in FIG. 2, ensures that an uninterrupted path exits between the array of mmWave antenna 205 and an external device. However, in some instances, some or all of the antenna of the array of mmWave antenna are located in the base member 203-2. Having some or all of the antenna of the array of mmWave antenna 205 be located in the display member 203-1 reduces a transmission distance between the array of mmWave antenna and an external device (e.g., a wireless mouse, stylus, etc.).

As mentioned, the photovoltaic component 204 such as the first photovoltaic component 204-1 and the second photovoltaic component 204-2 are disposed on an exterior surface of the housing 201. In some instances, the exterior surface is a front surface 214 of the display member 203-1, a back surface (opposite the front surface 214) of the display member 203-1, a top surface 211 of the display member 203-1, or any combination thereof. For instance, as illustrated in FIG. 2, the first photovoltaic component 204-1 and the second photovoltaic component 204-2 are located on a combination of the front surface 214 and the top surface 211. Having the photovoltaic component 204 located on the front surface 214 promotes the capture of light incident on the photovoltaic component 204 when the electronic device 220 is in the open position, as illustrated in FIG. 2. However, in some instances, the photovoltaic component 204 is located elsewhere such as being located exclusively on the top surface 211 of the base member 203-2.

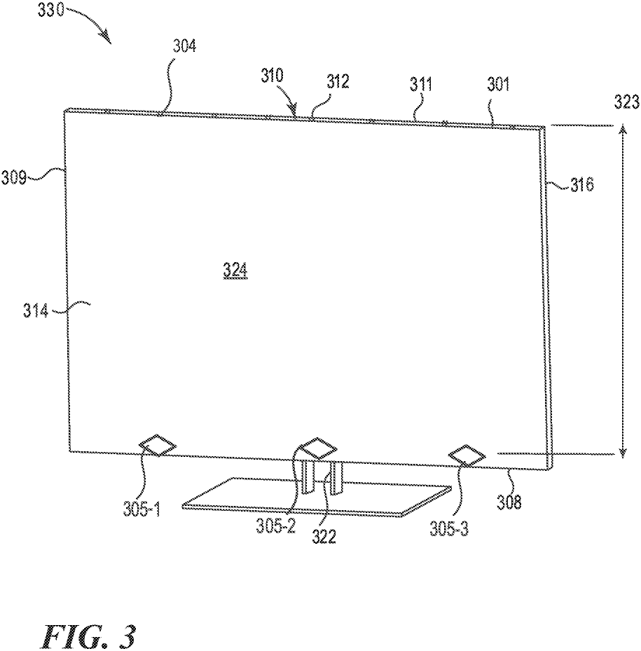

FIG. 3 illustrates a view of another example of an electronic device 300 including a photovoltaic component 304 and an array of mmWave antennas 305 suitable with wireless power transmission. The electronic device 330 includes a unitary housing 301. The housing 301 includes a plurality of exterior surfaces such as a bottom surface 308, a first side surface 309, a second side surface 316, a front surface 314, a top surface 311, and a back surface (opposite the front surface 314). As used herein, a front surface refers a portion of the electronic device that has a display panel/touchscreen/graphical user interface of the electronic device 330, while the back surface refers to a portion of the electronic device that is opposite from the front surface.

As used herein, the bottom surface refers to a portion of the electronic device 330 that is proximate to a stand and/or a base member on which the electronic device 330 is resting, while the top surface 111 refers to a portion of the electronic device 330 that is opposite the bottom surface. As used herein, a side surface refers to a surface located between a bottom surface and a top surface of the electronic device 330.

As illustrated in FIG. 3, the housing 301 is coupled to the stand 322. The stand refers to a physical device that extends from the housing 301 and/or a separate entity that is capable of being coupled to the housing 301. The stand 322 stabilizes and/or elevates a display 324 above a surface on which the electronic device 330 is disposed. While FIG. 3 illustrates the presence of the stand 322, in some examples the electronic device 330 is a laptop or other device without a stand.

The display 324 includes a graphical user interface and/or a liquid crystal display. The display 324 includes a touchscreen, in some instances. A touchscreen refers to an input and/or output device layered on top of an electronic visual display (e.g., monitor) of an electronic device to receive a touch input. The touchscreen facilitates a user to interact directly with what is displayed (e.g., icons on a graphical user interface (GUI) displayed by the electronic device, a virtual keyboard, GUI components of instructions executing on the electronic device, pictures, videos, etc.).

The photovoltaic component 304, as illustrated in FIG. 3, extends along an entirety of the top surface 311 of the electronic device 330. As mentioned, in some instances the photovoltaic component 304 is a distance 323 away from the array of mmWave antennas 305. For instance, the photovoltaic component 304 is on the top surface 311, while the array of mmWave antennas 305 is located inside of the electronic device 330 at a location near the front surface 314 and/or near the bottom surface 308. As mentioned, such an orientation readily permits generation of solar power and also readily permits power transmission (e.g., by minimizing a transmission distance) between the array of mmWave antennas 305 (e.g., a first mmWave antenna 305-1, a second mmWave antenna 305-2, and a third mmWave antenna 305-3) and an external device receiving the transmitted solar power from the array of mmWave antennas 305.

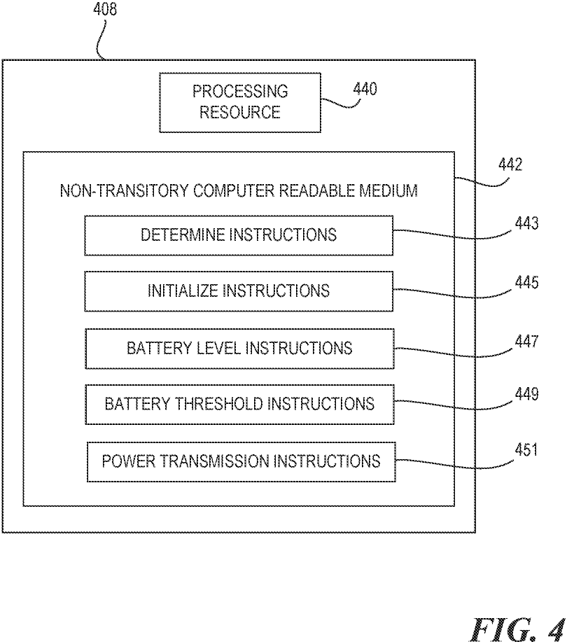

FIG. 4 illustrates a diagram of an example of a controller 408 suitable with wireless power transmission. As illustrated in FIG. 4, the controller 408 includes a processing resource 440 and a non-transitory computer readable medium 442.

The processing resource 440 includes a central processing unit (CPU), a semiconductor based microprocessor, and/or other hardware devices suitable for retrieval and execution of machine-readable instructions such as those stored on the non-transitory computer readable medium 442. The term “non-transitory” does not encompass transitory propagating signals.

The non-transitory computer readable medium 442 is any electronic, magnetic, optical, or other physical storage device that stores executable instructions. For example, non-transitory computer readable medium 442 in some instances is a Random Access Memory (RAM), an Electrically-Erasable Programmable Read-Only Memory (EEPROM), a storage drive, an optical disc, and the like.

The executable instructions are “installed” on the controller 408 illustrated in FIG. 4 and/or “downloadable” to the controller as a portable, external, or remote storage medium, for example, that allows the controller 408 to download instructions from the portable/external/remote storage medium. In this situation, the executable instructions are part of an “installation package”. As described herein, non-transitory computer readable medium 442 is encoded with executable instructions related to wireless power transmission.

The processing resource 440 executes determine instructions 443 to determine a battery level in a battery of an electronic device (e.g., electronic device 100, electronic device 220, and/or electronic device 330, as described herein). For instance, the processing resources receives respective signals from a battery and/or circuitry coupled to the battery that are indicative of a real-time battery level of the battery of the electronic device. For instance, the determine instructions 443 are executed to determine a respective battery level of the battery during a session of use of an electronic device. In some instances, the determine instructions 443 are executed to periodically determine the battery levels, for instance, periodically during a session of use of the electronic device. However, in some instances, the real-time battery levels are determined responsive to an input (e.g., an input provided by the user of the electronic device), among other possibilities.

The processing resource 440 compares the determined battery level, as determined at 443, to an initialization threshold. For instance, a battery level such as a value and/or percentage indicative of an amount of charge in a battery (e.g., 60%) are compared to a value/and/ percentage of the initialization threshold (e.g., 50%), among other possibilities. Such comparison determines whether or not the battery level (e.g., 60%) is greater than the initialization threshold (e.g., 50%).

The processing resource 440 executes initialize instructions 445 to determine when a battery level determined to be greater than the initialization threshold and to initialize the mmWave power transmission module responsive to a determination that the battery level is greater than the initialization threshold. For instance, the mmWave power transmission module proceeds from a standby/sleep/low power state (e.g., at which the mmWave antenna array is not transmitting and is not charged or otherwise ready to proceed with wireless power transmission) to an active/high power state when initialized (e.g., at which the array of mmWave antennas is not actively transmitting mmWave solar power but when a capacitor or other circuitry is charged and the array of mmWave antennas is ready to proceed with wireless power transmission). However, when the battery level is less than (or equal to) the initialization threshold the mmWave power transmission module remains uninitialized (e.g., until it is determined the battery level is greater than the initialization threshold). In some instances, the initialization threshold is specific to the electronic device. For instance, the initialization threshold is based on a battery capacity of a battery in a device, a transmission power of the array of mmWave antennas in the electronic device, or other consideration.

The processing resource 440 executes battery level instructions 447 to determine a battery level in an external device. For instance, the battery level instructions 447 when executed receive a signal transmitted from the external device that is indicative of a battery level of the external device and/or transmission of a signal from the electronic device to cause emission of a response signal transmitted from the external device that is indicative of a battery level of the external device. In some instances, the processing resource 440 executes battery level instructions 447 to determine a battery level in an external device responsive to initialization of the mmWave power transmission module and/or responsive to a determination that the battery level in the electronic device is greater than the initialization threshold. For instance, in some examples, a signal is emitted from the electronic device such as from the mmWave antennas to determine a presence of and a battery level of any external devices that are within a transmission distance of the mmWave antennas of the electronic device.

The processing resource 440 executes battery threshold instructions 449 to compare the battery level in the external device to a battery threshold. The battery threshold refers to a value or percentage at which the external device is suitable for charging. For instance, responsive to determination that the battery level of the external device is less than the battery threshold, the processing resource 440 executes power transmission instructions 451 to cause the transmission of the amount of solar power generated by a photovoltaic component (e.g., a solar panel) to charge the battery in the external device. Such transmission continues until the amount of solar power generated by the solar panel until the battery level in the electronic device is less than the initialization threshold or the battery level in the external device is greater than the battery threshold. Stated differently, mmWave transmission of the solar power continues until battery level in the electronic device is no longer sufficient to readily permit mmWave transmission of solar power or until the battery level in the external device is sufficiently charged.

The processing resource 440 executes alert instructions (not illustrated) to provide an alert responsive to the determination that the battery level is greater than an initialization threshold, an alert responsive to the mmWave power transmission module being initialized (e.g., ready to transmit mmWave solar power), an alert responsive to initiation of transmission of mmWave solar power to an external device, etc. The alerts are provided as an audio alert, a visual alert, a haptic alert, or any combination thereof. For instance, the alert is provided as a visual alert (e.g., text, icons, etc.) displayed by a display panel in an electronic device, such as those described herein.

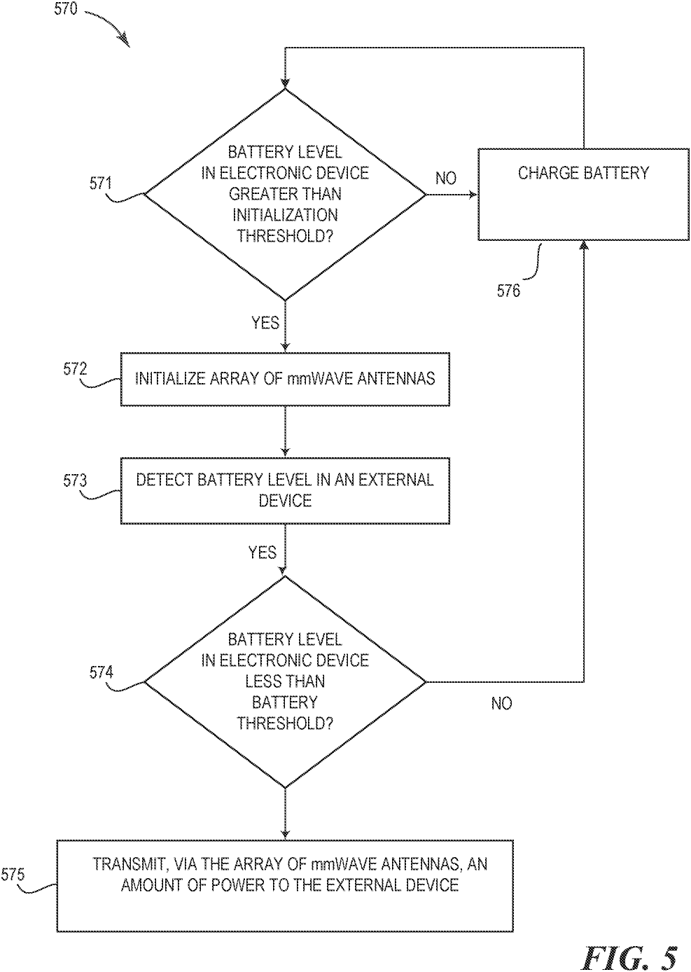

FIG. 5 illustrates an example of a flow diagram of a flow 570 for providing wireless power transmission. At 571, the flow includes determination of a battery level of a battery included in the electronic device. Responsive to a determination that the battery level is less than (or equal to) the initialization threshold the flow 570 stops or await a subsequent initiation of the flow 570 during which time the battery is charged with solar power, as indicated at 576. In such instances, the array of mmWave antennas is not initialized (e.g., to avoid further drain on the battery in the electronic device). For example, initialization the array of mmWave antennas is delayed until the battery level is greater than the initialization threshold. Responsive to a determination that the battery level is greater than an initialization threshold the flow 570 proceeds to 572.

At 572, the mmWave power transmission module is initialized. As mentioned, initializing the mmWave power transmission module permits radio transmission, via the array of mmWave antennas, of the amount of solar power generated by the solar panel to the external device.

At 573, a battery level of an external device is detected, as detailed herein. At 574, the detected battery level is compared to a battery threshold. Responsive to a determination that the detected battery level is greater than (not less than or equal to) the battery threshold the flow 570 stops or await a subsequent initiation of the flow 570 during which time the battery is charged with solar power, as indicated at 576. In such instances, the mmWave power transmission module is deinitialized (e.g., to mitigate any power drained from the battery in the electronic device by the mmWave power transmission module or in some instances remains initialized. Conversely, responsive to a determination that the detected battery level is less than the battery threshold the flow 570 proceeds to 575. At 575, the amount of solar power generated by the solar panel is transmitted to the external device via the array of mmWave antennas, as detailed herein.

In the foregoing detailed description of the disclosure, reference is made to the accompanying drawings that form a part hereof, and in which is shown by way of illustration how examples of the disclosure. These examples are described in sufficient detail to enable those of ordinary skill in the art to practice the examples of this disclosure, and it is to be understood that other examples (e.g., having a different thickness) are possible and that process, electrical, and/or structural changes can be made without departing from the scope of the disclosure.

The figures herein follow a numbering convention in which the first digit corresponds to the drawing figure number and the remaining digits identify an element or component in the drawing. For example, reference numeral 108 refers to element 108 in FIG. 1 and an analogous element can be identified by reference numeral 208 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

What is claimed is:

1. An electronic device, comprising:
a display member;
a base member rotatably coupled to the display member, the base member including an input component;
a photovoltaic component coupled to an exterior surface of the display member to generate an amount of solar power; and
an array of millimeter wave (mmWave) antennas to wirelessly transmit the amount of solar power to an external device.

2. The electronic device of claim 1, wherein the electronic device includes a battery coupled to the photovoltaic component.

3. The electronic device of claim 1, wherein the photovoltaic component is a solar panel.

4. The electronic device of claim 1, wherein the array of mmWave antennas is located inside of the display member.

5. The electronic device of claim 4, wherein the exterior surface is a front surface of the display member, a back surface of the display member, a top surface of the display member, or any combination thereof.

6. The electronic device of claim 4, wherein the array of mmWave antennas further comprises printed antennas, patch antennas, dipole antennas, monopole antennas, Yagi-uda antennas, slot antennas, or a combination thereof.

7. An electronic device comprising:
a housing;
a solar panel coupled to an exterior surface of the housing to generate an amount of solar power;
a millimeter wave (mmWave) power transmission module including:
a printed circuit board (PCB);
a mmWave front end component coupled to the PCB; and
an array of mmWave antennas coupled to the PCB; and
a power management controller to cause radio transmission, via the array of mmWave antennas, of the amount of solar power generated by the solar panel to an external device.

8. The electronic device of claim 7, wherein the mmWave is to transmit the amount of solar power generated by the solar panel at radio frequency in a range from 30 gigahertz (GHz) to 300 GHz.

9. The electronic device of claim 7, wherein the array of mmWave antennas is disposed on a first surface of the PCB, a second surface of the PCB which is opposite the first surface of the PCB, or a combination thereof.

10. The electronic device of claim 7, wherein the power management controller is to:
determine a battery level of a battery in the electronic device is greater than an initialization threshold;
responsive to determining the battery level is greater than the initialization threshold, initialize the mmWave power transmission module;
determine, via the array of mmWave antennas, a presence of the external device and a battery level of the external device;
determine the battery level of the external device is less than a battery threshold; and
cause the transmission of the amount of solar power generated by the solar panel responsive to the determination that the battery level is less than the battery threshold.

11. The electronic device of claim 10, wherein the power management controller is to cause the transmission of the amount of solar power generated by the solar panel until i) the battery level in the electronic device is less than the initialization threshold; or ii) the battery level in the external device is greater than the battery threshold.

12. An electronic device comprising:
a display member having a housing including a plurality of exterior surfaces including a top surface, a bottom surface, a front surface and a back surface;
a solar panel to generate an amount of solar power;
a battery to store the amount of power generated by the solar panel;
a millimeter wave (mmWave) power transmission module including:
a printed circuit board (PCB);
a mmWave front end component coupled to the PCB; and
an array of mmWave antennas coupled to the PCB; and
a power management controller to:
determine a battery level in the battery is greater than an initialization threshold;
responsive to the determination the battery level is greater than the initialization threshold, initialize the mmWave power transmission module;
determine a battery level of an external device;
determine the battery level of the external device is less than a battery threshold; and
cause radio transmission, via the array of mmWave antennas, of the amount of solar power generated by the solar panel to the external device.

13. The electronic device of claim 12, wherein the solar panel is coupled to the top surface.

14. The electronic device of claim 13, wherein the battery is located inside of the housing adjacent to the top surface.

15. The electronic device of claim 13, wherein the mmWave power transmission module is located inside of the housing, and wherein the mmWave power transmission module is located adjacent to the bottom surface.
